(19) United States
(12) Patent Application Publication
(10) Pub. No.: US 2024/0187222 A1
(43) Pub. Date: Jun. 6, 2024

(54) SECURE REMOVABLE HARDWARE WITH PUF

(71) Applicant: TELEFONAKTIEBOLAGET LM ERICSSON (PUBL), STOCKHOLM (SE)

(72) Inventors: Niklas Lindskog, LUND (SE); Håkan Englund, LUND (SE)

(21) Appl. No.: 18/287,851

(22) PCT Filed: Apr. 23, 2021
(86) PCT No.: PCT/IB2021/053390

§ 371 Date: Oct. 20, 2023

(51) Int. Cl. H04L 9/08; H04L 9/32

(52) U.S. Cl. CPC H04L 9/0866; H04L 9/3278; H04L 2209/34

(57) ABSTRACT

Systems and methods are disclosed herein for providing a secure hardware component for protecting cryptographic keys used in relation to a client device by using a Physically Unclonable Function (PUF) and, in some embodiments, client device authorization. In one embodiment, the secure hardware component comprises an Input/Output (I/O) port, a key generation subsystem, and a cryptographic module. The key generation subsystem comprises the PUF and receives first data related to at least one cryptographic algorithm from the client device, via the I/O port, and generates a key for the at least one cryptographic algorithm in accordance with the first data using the PUF. The cryptographic module receives second data from the client device and generates third data based on the second data and the key, and provides the third data to the client device. Accordingly, the client device is better protected from external attacks.

### TECHNICAL FIELD

Systems and methods of the present disclosure generally relate to secure hardware for electronically securing electronic devices using security keys generated by Physically Unclonable Functions (PUFs).

### BACKGROUND

Physically Unclonable Functions (PUFs) are circuits, components, processes, or other entities capable of generating an output, such as a key, a digital identity, or authentication data. A PUF should be resistant to cloning. For example, a device that has a PUF would be difficult to clone to generate the same output of the PUF with another device.

### Physically Unclonable Functions (PUFs)

PUFs are used to create a unique response by using implicit or explicit randomness. This response can be used for cryptographic or device identity purposes. Implicit randomness may include unpredictable manufacturing differences in semiconductor devices that can be exploited to create a device-unique response. On the other hand, explicit randomness means that the introduction of randomness requires extra steps during manufacturing or a later stage, e.g., at packaging.

A PUF comprises one or several subfunctions, sometimes called elements or components, which each contributes a part of the PUF response. One example of the subfunctions of a PUF may be a ring-oscillator pair. A ring oscillator is formed by an uneven number of signal inverters in a ring, where gate delay propagation is used as a randomness source. The PUF response is based on a comparison between the two ring-oscillators where the number of oscillations at a given point is measured. In particular, the PUF response may be an identifier of the fastest ring oscillator or slowest ring oscillator. Another example of the subfunctions of a PUF may be uninitialized Static Random Access Memory (SRAM) cells, which have two possible states (0 and 1). Prior to power-up, the SRAM cell is in neither state. At power-up, the SRAM cell stabilizes in one of the two states. The PUF response is the entered state of a set of SRAM cells. Yet another example is an arbiter. An arbiter might be regarded as a digital race condition between two or more signal paths on a chip where a so-called arbiter circuit identifies the winning signal. The paths might comprise several switch blocks, which can alter the signal paths. The PUF response, in this case, can, e.g., be the ID of the winning signal. In some PUF entities, the same subfunction(s) might generate several outputs by utilizing different parts of the PUF challenge. Each subfunction also has the property that it is physically unclonable, i.e., unique for the device. A PUF may therefore comprise several subfunctions which can be used as independent PUFs, albeit with fewer possible challenges and fewer response bits.

The PUF response can be used to create a unique device identity or a device unique key without having to store the key in, e.g., Battery Backup Random Access Memory (BBRAM) or One Time Programmable (OTP) memory. Hence, it is much harder for an attacker to mount certain types of hardware attacks with the goal of recovering the key from a device using a PUF.

There are several types of PUFs, but all PUFs accept a challenge as input. The PUFs generally translate the challenge into either (i) a selection of at least one element within the PUF or (ii) a configuration of at least one element within the PUF. Depending on what type of PUF is used, the number of challenges, which are accepted by the PUF, can vary from just one to an exponential amount related to the number of subfunctions. In the present disclosure, the challenge is considered to be an input to the PUF that creates a specified number of response bits. The present disclosure may include activating the PUF several times using different subsections of the challenge where each subsection generates at least one part of the response.

Most PUF types additionally require helper data to function properly, i.e., to increase the possibility of recreating the same response given the same challenge. Some PUF types can remap the challenge-response mapping one or several times. i.e., after the remapping, some or all challenges may result in new responses.

A reconfigurable PUF can alter the entire challenge space, e.g., to make sure that all challenges receive a new response. An erasable PUF is a PUF that has the possibility to change responses of specific challenges. Alternatively, the PUF might respond with a null sequence, for example, all zeros, for challenges marked as “erased.” When a PUF response (or a derivation thereof) is used to encrypt another cryptographic key, the PUF response is called Key Encryption Key (KEK).

### Secure Hardware Component (SHC)

SHC, Secure Removable Hardware Module (SRHM), and Secure Removable Hardware Component (SRHC) are terms used interchangeably in the present disclosure, which commonly refer to a cryptographic module connected to an external interface of a client device. Such a client device can, e.g., be embodied by a computer or mobile device. The cryptographic module can be implemented as a Hardware Security Module (HSM) or a Secure Element (SE).

An HSM is an external or embedded component intended to protect cryptographic keys and provide cryptographic services. Such services may include encryption, decryption, cryptographic signatures, and validation of key wrapping. An HSM comes in different shapes and areas of use, which can be either standalone, i.e., a network device storing the keys for several devices, or a plugin device belonging to a specific server or computer. Traditional HSMs are usually installed in racks in large server rooms. In the present disclosure, smaller form factors of removable types are considered. In the plugin device, the keys stored in the device are used for a single individual and/or machine. Such HSMs are commonly accessed via a Universal Serial Bus (USB) port. There are, however, HSMs with similar form factors as SEs, e.g. smart cards and micro Secure Digital (SD) cards.

SE is a term commonly defined as a tamper resistant chip capable of running applications and protecting the confidentiality and integrity of their related data and code. There are embedded and integrated SEs, but removable SEs, such as Subscriber Identity Module (SIM)/Universal Integrated Circuit Card (UICC), smart cards, and smart microSDs are mostly interesting SEs. SE and HSM are usually tamper protected and may have features to erase keys as a countermeasure to hardware probing.

UICC or smart cards usually have a very limited set of resources and only external power sources. They have a standardized physical interface and can normally contain several applications. UICC or smart cards are commonly used for storing sensitive keys and require cryptographic components. As used in the present disclosure, “USB” contains devices ranging from smart cards with a USB interface to more capable devices, sometimes referred to as USB-HSMs. Wireless form factors are similar to smart cards, but the wireless form factors use a wireless protocol to communicate with a host, e.g., Bluetooth (low energy), Radio Frequency Identification (RFID), or Near Field Communication (NFC).

### Related Art

Several solutions covering SRHMs exist. One common technique is to use a protective coating and to store the keys in Non-Volatile Memory (NVM), OTP, or BBRAM. These solutions can be sensitive to hardware attacks such as Scanning Electron Microscope (SEM) and Focused Ion Beams (FIBs).

U.S. Pat. No. 9,071,446 (TAMPER-PROTECTED HARDWARE AND METHOD FOR USING SAME) (hereinafter “Kreft”) describes an HSM with a PUF. In Kreft, a protective layer around the HSM, called a “cocoon,” influences or creates a PUF response. The PUF of Kreft is mainly used as a tamper detection solution, where an alteration of the value indicates hardware tampering.

U.S. Pat. No. 10,680,809 (PHYSICAL UNCLONABLE FUNCTION FOR SECURITY KEY) (hereinafter “Chang”) describes a device that generates keys using a PUF and a Random Number Generator (RNG) device. The keys of Chang are stored in a PUF key store (on-chip NVM memory). The keys in the PUF key store may be encrypted by a KEK. Upon request, the key is provided to an external device.

A paper titled “An Embedded Key Management System for PUF-based Security Enclosure” (Obermaier et al., 7^{th} Mediterranean Conference on Embedded Computing, 2018) (hereinafter “Obermaier”) describes an HSM with a PUF. In this paper, the HSM uses a KEK to protect keys stored on the HSM. The PUF of Obermaier is built into the protecting shell of the HSM. If hardware tampering occurs, the shell is altered, and the KEK is no longer available.

In U.S. Pat. No. 9,876,647 (APPARATUS FOR PROVIDING PUF-BASED HARDWARE OTP AND METHOD FOR AUTHENTICATING 2-FACTOR USING SAME) (hereinafter “Kim”), a device authentication framework is presented where device PUFs generate one-time passwords for authentication purposes. In some embodiments of Kim, a Personal Identification Number (PIN) and an asymmetric private key are generated by separate PUFs as inputs to symmetric and asymmetric cryptographic primitives to respond to a challenge (in a challenge-response procedure) on the device. However, the solution of Kim focuses on authentication and does not support generation of multiple keys.

In U.S. Pat. No. 8,762,723 (CRYPTOGRAPHIC SECURITY USING FUZZY CREDENTIALS FOR DEVICE AND SERVER COMMUNICATIONS) (hereinafter “Yu”), a system where the inaccuracy of certain PUFs is used for creating variability in an authentication and key agreement protocol to make side-channel attacks harder. The PUF of Yu is challenged and produces a (potentially) slightly inaccurate response that is returned to the server. The server of Yu determines if the result is sufficiently accurate; if so, the device is authenticated. The response is also used for session key generation during session encryption/decryption. Due to the inherent variability of key generation from time to time, the system of Yu is used to generate session keys.

### SUMMARY

Systems and methods are disclosed herein for providing a Secure Hardware Component (SHC) (alternatively, a Secure Removable Hardware Module (SRHM)) for protecting cryptographic keys used in relation to a client device by using a Physically Unclonable Function (PUF) and, in some embodiments, client device authorization in the SHC. The SHC is, in a preferred embodiment, a Secure Removable Hardware Component (SRHC) that is removable from the client device. By using embodiments of the present disclosure, the client device is better protected from external attacks.

In one embodiment, an SHC comprises an Input/Output (I/O) port configured to exchange data with a client device, a key generation subsystem coupled to the I/O port, and a cryptographic module. The key generation subsystem comprises a PUF and is configured to receive first data related to at least one cryptographic algorithm from the client device via the I/O port and generate a key for the at least one cryptographic algorithm in accordance with the first data using the PUF. The cryptographic module is configured to receive second data from the client device via the I/O port, generate third data based on the second data and the key, and provide the third data to the client device via the I/O port.

In one embodiment, the secure hardware component is removable from the client device. In one embodiment, the cryptographic module is reset after finishing one or more iterations of the steps of receiving the second data, generating the third data based on the second data and the key, and providing the third data to the client device via the I/O port. In one embodiment, the first data comprises (a) an identifier associated with at least one of a service, a memory area, or an application, (b) an indicator of the at least one cryptographic algorithm, (c) a number of bits as a size of the key, (d) an Initialization Vector (IV), (e) a counter related to a block of data to be encrypted, (f) additional data related to an encryption algorithm and mode of operation, (g) additional data related to the generation of a cryptographic key, or (h) a combination of any two or more of (a)-(g).

In one embodiment, the key generation subsystem further comprises a challenge creation function and a Key Derivation Function (KDF), where the challenge creation function is configured to produce a challenge based on the first data and the PUF is configured to generate a PUF response based on the challenge, and the KDF is configured to generate the key based on the PUF response. In one embodiment, the key generation subsystem further comprises a challenge creation function, a PUF correction module, and a KDF. The challenge creation function is configured to produce a challenge based on the first data. The PUF is configured to generate a PUF response based on the challenge. The PUF correction module is configured to apply an error correction to the PUF response to provide an error-corrected PUF response. The KDF is configured to generate the key based on the error-corrected PUF response. In one embodiment, the challenge creation function comprises a One-Way Function (OWF). In one embodiment, the challenge creation function comprises a Lookup Table (LUT). In one embodiment, the challenge creation function comprises a deterministic Pseudo Random Number Generator (PRNG).

In one embodiment, the cryptographic module is configured to generate the third data by encrypting the second data with the key. In one embodiment, the cryptographic module is configured to generate the third data by decrypting the second data with the key.

In one embodiment, the cryptographic module is configured to check a validity of the key before the cryptographic module generates the third data based on the second data and the key. In one embodiment, the cryptographic module is configured to check the validity of the key by decrypting a known ciphertext with the key. In one embodiment, the cryptographic module is configured to check the validity of the key by checking the key against a corresponding public key. In one embodiment, the cryptographic module is configured to check the validity of the key by calculating a one-way transformed version of the key and comparing it against a stored one-way transformed version of the key.

In one embodiment, the secure hardware component further comprises a registration module. The registration module is configured to receive a first credential from the client device via the I/O port during a registration phase, utilize the key generation subsystem to generate a response based on the first credential, and save a first authentication data at the secure hardware component. The first authentication data is based on the response generated by the key generation subsystem based on the first credential. In one embodiment, the first authentication data is additionally based on the first credential. Alternatively, the first authentication data is based on a credential and a response generated by the key generation subsystem based on a predefined challenge.

In one embodiment, the secure hardware component further comprises an authentication module. The authentication module is configured to receive a second credential from the client device via the I/O port during an authentication phase, utilize the key generation subsystem to generate a response based on the second credential, and compare a second authentication data with the first authentication data to authenticate the second credential. In one embodiment, the second authentication data is additionally based on the second credential. Alternatively, the second authentication data is based on a credential and a response generated by the key generation subsystem based on a predefined challenge.

In one embodiment, the secure hardware component further comprises a registration module configured to receive a first credential from the client device via the I/O port during a registration phase, utilize the key generation subsystem to generate a response based on a predefined challenge, create a first authentication data based on the response and the first credential, and save a first authentication data at the secure hardware component.

In one embodiment, the secure hardware component further comprises an authentication module configured to receive a second credential from the client device via the I/O port during an authentication phase, utilize the key generation subsystem to generate a response based on a predefined challenge, create a second authentication data based on the response and the second credential, and compare a second authentication data with the first authentication data to authenticate the second credential.

In one embodiment, the secure hardware component further comprises a registration module configured to receive a first authentication data comprising a public key or a digital certificate from the client device via the I/O port during a registration phase and save the first authentication data at the secure hardware component. The secure hardware component further comprises an authentication module configured to receive a second authentication data via the I/O port during the authentication phase and verify the authenticity of the second authentication data with a public key received in the first authentication data in the registration phase. The authentication module may additionally send a number used once (nonce) to the client. In this case, the second authentication data may be derived using the nonce.

Corresponding embodiments of a method implemented in a secure hardware component are also disclosed. In one embodiment, a method implemented in a secure hardware component comprising an I/O port, a key generation subsystem comprising a PUF, and a cryptographic module is provided. The method comprises, at the key generation subsystem, receiving first data related to at least one cryptographic algorithm from a client device via the I/O port and generating a key for the at least one cryptographic algorithm in accordance with the first data using the PUF. The method further comprises, at the cryptographic module, receiving second data from the client device via the I/O port, generating third data based on the second data and the key, and providing the third data to the client device via the I/O port.

In one embodiment, the secure hardware component in the method is removable from a client device. In one embodiment, the method further comprises resetting the cryptographic module after finishing one or more iterations of the steps of receiving the second data, generating the third data based on the second data and the key, and providing the third data to the client device via the I/O port.

In one embodiment, the first data in the method comprises (a) an identifier associated with at least one of a service, a memory area, or an application, (b) an indicator of the at least one cryptographic algorithm, (c) a number of bits as a size of the key, (d) an Initialization Vector, (e) a counter related to a block of data to be encrypted, (f) additional data related to an encryption algorithm and mode of operation, (g) additional data related to the generation of a cryptographic key, or (h) a combination of any two or more of (a)-(g).

In one embodiment, the method further comprises, at the key generation subsystem comprising a challenge creation function and a KDF, producing a challenge based on the first data, generating, by the PUF, a PUF response based on the challenge, and generating the key based on the PUF response. In one embodiment, the method further comprises, at the key generation subsystem further comprising a challenge creation function, a PUF correction module, and a KDF, producing a challenge based on the first data, generating, by the PUF, a PUF response based on the challenge, applying an error correction to the PUF response to provide an error-corrected PUF response, and generating the key based on the error-corrected PUF response.

In one embodiment, the challenge creation function comprises a One-Way Function (OWF). In one embodiment, the challenge creation function in the method comprises a LUT. In one embodiment, the challenge creation function in the method comprises a deterministic PRNG.

In one embodiment, generating the third data comprises encrypting the second data with the key. In one embodiment, generating the third data comprises decrypting the second data with the key. In one embodiment, the method further comprises checking a validity of the key before generating the third data based on the second data and the key. In one embodiment, checking the validity of the key comprises checking the validity of the key by decrypting a known ciphertext with the key. In one embodiment, checking the validity of the key comprises checking the validity of the key by checking the key against a corresponding public key. In one embodiment, checking the validity of the key comprises checking the validity of the key by calculating a one-way transformed version of the key and comparing the one-way transformed version of the key against a stored one-way transformed version of the key.

In one embodiment, the method further comprises receiving a first credential from the client device via the I/O port during a registration phase, utilizing the key generation subsystem to generate a response based on the first credential, and saving a first authentication data at the secure hardware component. The first authentication data is based on the response generated by the key generation subsystem based on the first credential.

In one embodiment, the first authentication data is additionally based on the first credential. In one embodiment, the method further comprises receiving a second credential from the client device via the I/O port during an authentication phase, utilizing the key generation subsystem to generate a response based on the second credential, and comparing a second authentication data with the first authentication data to authenticate the second credential, the second authentication data being based on the response generated by the key generation subsystem based on the second credential.

In one embodiment, the second authentication data is additionally based on the second credential. In one embodiment, the method further comprises receiving a first credential from the client device via the I/O port during a registration phase, utilize the key generation subsystem to generate a response based on a predefined challenge, create a first authentication data based on the response and the first credential, and save the first authentication data at the secure hardware component. In one embodiment, the method further comprises receiving a second credential from the client device via the I/O port during an authentication phase, utilizing the key generation subsystem to generate a response based on the second credential, and comparing a second authentication data with the first authentication data to authenticate the second credential.

In one embodiment, the method further comprises receiving a first authentication data comprising one or more of (a) a public key and (b) a digital certificate from the client device via the I/O port during a registration phase and saving the first authentication data at the secure hardware component.

In one embodiment, the method further comprises receiving a second authentication data via the I/O port during an authentication phase and verifying authenticity of the second authentication data with a public key received in the first authentication data in the registration phase.

In one embodiment, the method further comprises generating a number-used-once (nonce), sending the nonce to the client device, wherein the second authentication data is derived by using the nonce.

### BRIEF DESCRIPTION OF THE DRAWINGS

The accompanying drawing figures incorporated in and forming a part of this specification illustrate several aspects of the disclosure, and together with the description, serve to explain the principles of the disclosure. Optional features are represented by dashed boxes.

FIG. 1 is an example of a secure hardware component that implements embodiments of the present disclosure.

FIG. 2 is a flow diagram illustrating a method implemented in the secure hardware component connected to a client device to generate and use a key in accordance with some embodiments of the present disclosure.

FIG. 3A is a flow diagram illustrating a method implemented in the secure hardware component for generation of a key in accordance with some embodiments of the present disclosure.

FIG. 3B is a flow diagram illustrating another method implemented in the secure hardware component for generation of a key in accordance with some embodiments of the present disclosure.

FIG. 4A is a flow diagram illustrating a method implemented in the secure hardware component for registration and authentication in accordance with some embodiments of the present disclosure.

FIG. 4B is a flow diagram illustrating a method implemented in the secure hardware component for registration and authentication in accordance with some embodiments of the present disclosure.

FIG. 5 is a flow chart illustrating a method implemented in the secure hardware component for a first-time generation of a cryptographic key.

FIG. 6 is a flow chart illustrating a method implemented in the secure hardware component for recreation of a previously produced cryptographic key.

FIG. 7 is a flow chart illustrating a method implemented in the secure hardware component for another registration mode with a biometric input in accordance with some embodiments of the present disclosure.

FIG. 8 is a flow chart illustrating a method implemented in the secure hardware component for another authentication mode in accordance with some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some solutions, such as U.S. Pat. No. 9,071,446 (TAMPER-PROTECTED HARDWARE AND METHOD FOR USING SAME) (hereinafter “Kreft”) and “An Embedded Key Management System for PUF-based Security Enclosure” (Obermaier et al., 7th Mediterranean Conference on Embedded Computing, 2018) (hereinafter “Obermaier”), use the protective layer of a Hardware Security Module (HSM) to generate a Physically Unclonable Function (PUF) response. While those solutions provide tamper protecting, this PUF is automatically of weak type and can only be used for tamper detection and/or as a Key Encryption Key (KEK). While KEK solutions improve the security of a device, the KEK solutions create a so-called “single point of failure” in a system. That is, if the KEK is revealed, all stored keys are compromised at once.

However, those solutions do not disclose any contemporary HSM/Secure Element (SE) device that uses a PUF for key generation. For example, U.S. Pat. No. 10,680,809 (PHYSICAL UNCLONABLE FUNCTION FOR SECURITY KEY) (hereinafter “Chang”) describes a standalone device that generates a key, but the device of Chang does not have any authentication mechanism and/or HSM-like properties such as tamper protection. For example, U.S. Pat. No. 8,762,723 (CRYPTOGRAPHIC SECURITY USING FUZZY CREDENTIALS FOR DEVICE AND SERVER COMMUNICATIONS) (hereinafter “Yu”) describes a solution where session keys are generated by a non-error corrected output from a challenged PUF. However, the solution of Yu provides no possibility for deterministically deriving the same key on multiple occasions, nor does it provide PUF access control to the mechanism.

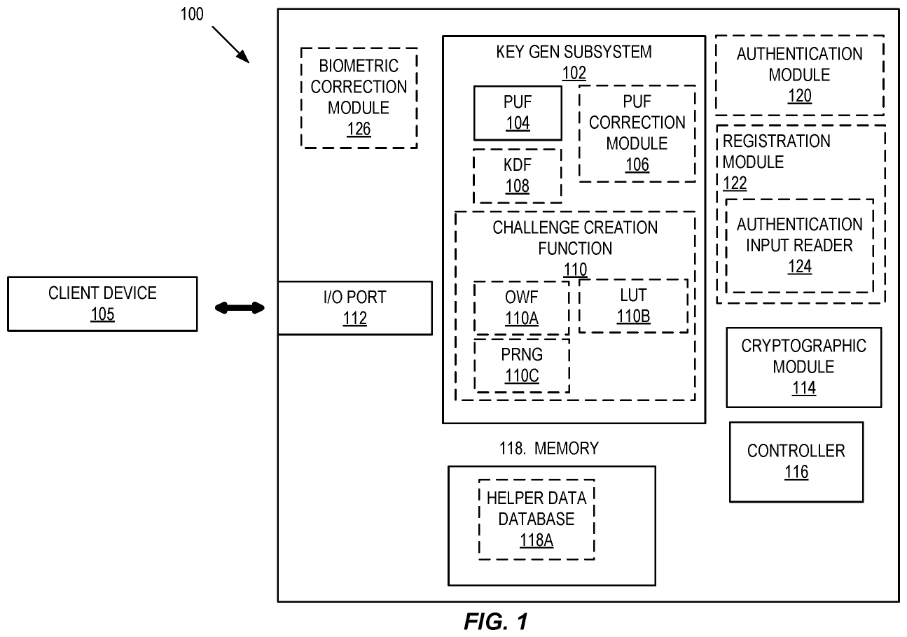

Systems and methods of the present disclosure are directed to a secure hardware component. The secure hardware component (SHC) is also referred to herein as a Secure Removable Hardware Module (SRHM). In this regard, FIG. 1 illustrates a secure hardware component 100 that includes a key generation subsystem 102. The key generation subsystem 102 includes a PUF 104. The secure hardware component 100 uses the PUF 104 and optionally client device authentication to protect keys generated by the secure hardware component 100 for a client device 105. Note that optional sub-components of the secure hardware component 100 are represented in FIG. 1 by dashed boxes.

The secure hardware component 100 is a hardware component (e.g., a Universal Serial Bus (USB) device or the like). The functionality of the secure hardware component 100 or its sub-components described herein may be implemented in software that is executed by a processor(s) (e.g., Central Processing Unit(s) (CPU(s)), Application Specific Integrated Circuit(s) (ASIC(s)), Field Programmable Gate Array(s) (FPGA(s)), and/or the like) within the secure hardware component 100 or implemented in a combination of hardware and software.

As illustrated in FIG. 1, the secure hardware component 100 includes the following sub-components. Again, note that optional components are represented by dashed lines/boxes.
Key Generation Subsystem 102: The key generation subsystem 102 includes the PUF 104. In addition, the key generation subsystem 102 may include a PUF correction module 106, a Key Derivation Function (KDF) 108, and a challenge creation function 110.
   PUF 104: The PUF 104 receives a challenge, for example, from the challenge creation function 110 and generates a device-unique response. The PUF 104 is preferably a PUF with a plurality of Challenge Response Pairs (CRPs). The PUF 104 may be implemented on, e.g., a Field-Programmable Gate Array (FPGA) or in an Application Specific Integrated Circuit (ASIC). However, the PUF 104 is not limited to being implemented on an FPGA or an ASIC. The PUF 104 may be implemented in any suitable type of hardware or any suitable combination of hardware and software.
   PUF Correction Module 106: The PUF correction module 106 applies error correction to recreate a PUF response, for example, by using helper data. For example, the PUF correction module 106 may be implemented (a) in software using a CPU, (b) in programmable logic on an FPGA, (c) as a pure hardware implementation, or (d) as any combination of software and hardware.
   KDF 108: The KDF 108 creates a cryptographic key from the PUF response. Depending on the cryptographic algorithm, the KDF 108 may comprise different components. For a cryptographic algorithm accepting uniform randomness as a key, a One-Way Function (OWF) such as a Message Authentication Code (MAC) function or a hash function could be used. In other cases, a more complex KDF function that creates a key satisfying a specific criterion of the cryptographic algorithm is needed. Examples of the KDF 108 are Argon2, Scrypt, and Password-Based Key Derivation Function 2 (PBKDF2).
   Challenge Creation Function 110: The challenge creation function 110 may include an OWF 110A, a Lookup Table (LUT) 110B, and a Pseudo Random Number Generator (PRNG) 110C.
      OWF 110A: The OWF 110A is a function that is easy to compute on every input, but hard to invert given the image of a random input. Examples of the OWF 110A are Message Authentication Code (MAC) functions and hash functions such as the SHA and BLAKE families.
      LUT 110B: The LUT 110B may be used, instead of the OWF 110A, to map inputs to valid challenges for the PUF 104.
      PRNG 110C: The PRNG 110C may also be used, in lieu of or in combination with the OWF 110A and the LUT 110B. The PRNG 110C uses the input as a seed and generates pseudorandom challenges of the desired length. For example, the PRNG 110C may comprise a Linear Feedback Shift Register (LFSR) or a Mersenne Twister.
Input/Output port 112: The I/O port 112 is used to communicate with the (external) client device 105. The I/O port 112 may be Public Key Cryptography Standards (PKCS) #11 compatible. For example, the I/O port 112 may be a USB or a Universal Integrated Circuit Card (UICC) physical interface (such as a Subscriber Identify Module (SIM) card), or a wireless interface (such as Near Field Communication (NFC) or Bluetooth).
Cryptographic module 114: The cryptographic module 114 handles cryptographic algorithms and may include a symmetric cryptographic engine and/or an asymmetric cryptographic engine (not shown). The symmetric cryptographic engine handles one or several symmetric cryptographic algorithms and/or message authentication codes. The asymmetric cryptographic engine handles one or several asymmetric cryptographic algorithms and/or signature schemes.
Controller 116: Examples of the controller 116 are Central Processing Units (CPUs), Application-Specific Integrated Circuits (ASICs), or Field Programmable Gate Arrays (FPGAs).
Memory 118: The memory 118 may be a non-volatile memory such as One Time Programmable (OTP) memory or an integrity-protected Multiple-Time Programmable (MTP) memory. The memory 118 stores a PUF-transformed authentication data. In some embodiments, the memory 118 stores helper data associated with the creation of cryptographic keys. In some embodiments, the memory 118 stores credentials and the PUF response associated with the authentication input.
   Helper data database 118A: The helper data database 118A is included in the memory 118. The helper data database 118A stores entries of error-correcting codes, which help to restore the PUF responses. In some embodiments, the helper data database 118A also stores entries of error correction codes corresponding to biometric input.
Authentication Module 120: The authentication module 120 receives client authentication input from the client device 105 via the I/O port 112. In some embodiments, in particular, when symmetric keys are used, the authentication module 120 sends the client authentication input to the key generation subsystem 102 to generate a response based on the credential and to create authentication data based on the response. The authentication module 120 verifies the authenticity of the authentication data. In some embodiments, the authentication data is based on a combination of the response and the credential. In this case, the response may be generated using a predetermined challenge, i.e., a challenge not based on the credential.
In an alternative embodiment, the authentication module 120 does not utilize the authentication input to generate a response based on the credential but instead verifies the client authentication input using a cryptographic key, in particular for asymmetric signatures where the verification is done with a non-sensitive public key. The authentication module 120 may also supply a number used once (nonce) which may be utilized by the client to create the authentication input.
Registration Module 122: The registration module 122 receives a credential from the client device 105 via the I/O port 112 during a registration phase. The registration module 122 utilizes the key generation subsystem 102 to generate a response based on the credential and saves authentication data based on the response in the memory 118 of the secure hardware component 100. In some embodiments, the authentication data is based on a combination of the response and the credential. In this case, the response may be generated using a predetermined challenge, i.e., a challenge not based on the credential. In an alternative embodiment, a public key is supplied to registration module 122 via the I/O port 112 during a registration phase to enable authentication using asymmetric cryptography. The public key may be supplied as a part of a digital certificate.
Authentication Input Reader 124: Examples of the authentication input reader 124 are (a) a biometrics reader reading a fingerprint or scanning a face or a retina and (b) a keypad reading a Personal Identification Number (PIN) or password.
Biometric Correction Module 126: The biometric correction module 126 uses error correction algorithms to, using helper data, attempt to recreate the original biometric data.

The secure hardware component 100 may have up to four operational modes: registration (optional), authentication (optional), generation, and operation. In the registration mode, a standalone registration procedure is performed. In the other three modes, the associated procedures are preferably performed in the order of authentication, generation, and operation. In the registration mode, the client device 105 registers with the secure hardware component 100 by entering a credential of a predetermined type. Examples of the credential are a password, a PIN, biometric data, a transformed version thereof, or a combination. This credential is sent through the key generation subsystem 102 and is used to create a challenge for the PUF 104. The PUF 104 generates a response, which is stored on the secure hardware component 100. The response (optionally with the credential) is used as authentication data to compare against during the authentication mode.

In one embodiment, the authentication mode requires that the client device 105 has registered a credential on the secure hardware component 100 using the registration mode. In the authentication mode, the client device 105 supplies a credential of the same type as during registration to secure hardware component 100. The credential is sent to the key generation subsystem 102 and is used to create a challenge for the PUF 104. The PUF 104 generates a response that is used to create authentication data. As the PUF response may differ somewhat between the two generations in the registration and authentication modes, in one embodiment, the authentication module 120 may allow some difference between the newly generated authentication data and the stored authentication data. If the client device 105 is not authenticated in the authentication mode, the secure hardware component 100 does not proceed to the next generation mode and instead aborts the process. An alternative implementation is to store helper data associated with the created authentication data during registration in order to facilitate the recreation of the same data when the client device 105 authenticates at a later point in time. If an attacker tampers with the PUF 104 and thereby changes its challenge-response mappings, authentication of the client device 105 becomes impossible as the PUF response needed to accept authentication is no longer available.

In the generation mode, which, in some embodiments, is entered after the client device 105 has been authenticated, the client device 105 provides first data to the secure hardware component 100. In one embodiment, the first data includes an identifier. For example, the identifier can be associated with a service, a memory area, or an application at the client device 105. Optionally, the first data provided by the client device 105 may also include a key size and an indication of one or more particular cryptographic algorithms for which the key should be used. In one embodiment, at least a portion of the first data provided by the client device 105 (e.g., the identifier) is sent to the key generation subsystem 102, which produces a challenge provided to the PUF 104 such that the PUF 104 generates a corresponding PUF response.

In one embodiment, if it is the first time that this particular key is being generated (e.g., the first time a key is generated using the specific identifier), helper data is provided to the client device 105. For subsequent generations, the client device 105 may then provide this helper data to the secure hardware component 100 (e.g., as part of the first data) to enable the secure hardware component 100 to recreate the original PUF response and thus the key.

In one embodiment, the helper data is stored on the client device 105 to facilitate the cryptographic keys to be used with any external device (for example, plug and play). In one embodiment, the client device 105 is access-protected by a client credential, such as a Personal Identification Number (PIN), password, or biometric input. Neither a PIN/password nor a template for the biometric input is stored on the client device 105. Instead, the stored authentication data is a specific PUF response, produced using a transformed version of the client credential as a challenge. The secure hardware component authenticates the client device 105 by supplying the authentication information to the PUF 104 and comparing the output to the stored authentication data.

Instead of letting the client device 105 store the helper data, the helper data can be stored in Non-Volatile Memory (NVM), such as the memory 118 on the secure hardware component 100. The helper data does not need to be encrypted but must be integrity protected to withstand hardware tampering, attacker-induced bit flips, etc. The stored helper data may be tagged with the identifier used to create the key.

The PUF response is, after extraction of error correction and using helper data, sent to the key generation subsystem 102. There, the KDF 108 deterministically generates a cryptographic key for the particular cryptographic algorithm(s) based on the PUF response. The KDF 108 may also use additional parameters, sometimes called a key context, when creating the cryptographic key. The parameters may comprise a number of bits, a cryptographic algorithm, usage restrictions, an identifier, etc.

In one embodiment, if the key is asymmetric and it is the first generation of the key, the corresponding public key is provided to the client device 105. As key validness is of utmost importance, an additional step may be performed to ensure that a valid key has been generated by the key generation subsystem 102 for the desired cryptographic algorithm(s). For example, in the symmetric case, the key can be checked by decrypting a known, previously-stored ciphertext. In the asymmetric case, key validness may be validated by checking it against the corresponding public key. The key can also be validated by calculating a one-way transformed version of the key and comparing it against a stored one-way transformed version of the key. If the key is found to be valid, the secure hardware component 100 moves into the operation mode.

In the operation mode, the generated key is loaded into the cryptographic module 114. The client device 105 provides data on which a cryptographic operation (e.g., encryption, creation of signature, decryption, etc.) is to be performed. The cryptographic module 114 performs the cryptographic operation on the data using the key and provides the resulting data back to the client device 105.

In the present disclosure, a predefined list of challenges may be stored on the secure hardware component 100. If the PUF 104 has a limited set of challenges, instead of using the key generation subsystem 102 to generate a challenge, an incoming identification (ID) can be linked to an entry in the predefined list of challenges using a LUT.

In one embodiment, no keys or challenges (optionally, no PUF helper data) are stored on the secure hardware component 100. An attacker must therefore have to access (a) the secure hardware component 100, (b) the PIN/password or biometric data (if applicable), and (c) the client device 105 altogether to access the cryptographic keys. Furthermore, the attacker, who can steal the stored authentication data, cannot extract any information that facilitates the authentication to the secure hardware component 100.

The secure hardware component 100 may be removable, i.e., only available to the (external) client device 105 when needed. The removability of the secure hardware component 100 may minimize exposure of the secure hardware component 100 when used with untrusted (external) client devices 105.

In a turned off/non-authenticated state, the secure hardware component 100 does not reveal any keys even if an attacker can physically alter the secure hardware component 100. Therefore, techniques like zeroization solutions are not needed when embodiments of the present disclosure are used.

Multiple keys may be generated by the same PUF 104 by using different challenges. This scheme allows the secure hardware component 100 to generate and recreate multiple keys without ever storing them, even in an encrypted form. Also, embodiments of the present disclosure may be used to decrypt a (part of a) boot component, which prevents the client device 105 from booting without the presence of the secure hardware component 100. In a device sharing use case, encrypted personalization data may be available to devices (e.g., an airplane screen, a rental car, a workplace, etc.) via cloud storage but, to be able to decrypt such encrypted personalization data, the secure hardware component 100 must be connected or plugged into the shared client device 105 either using wires or some close-range communication interface.

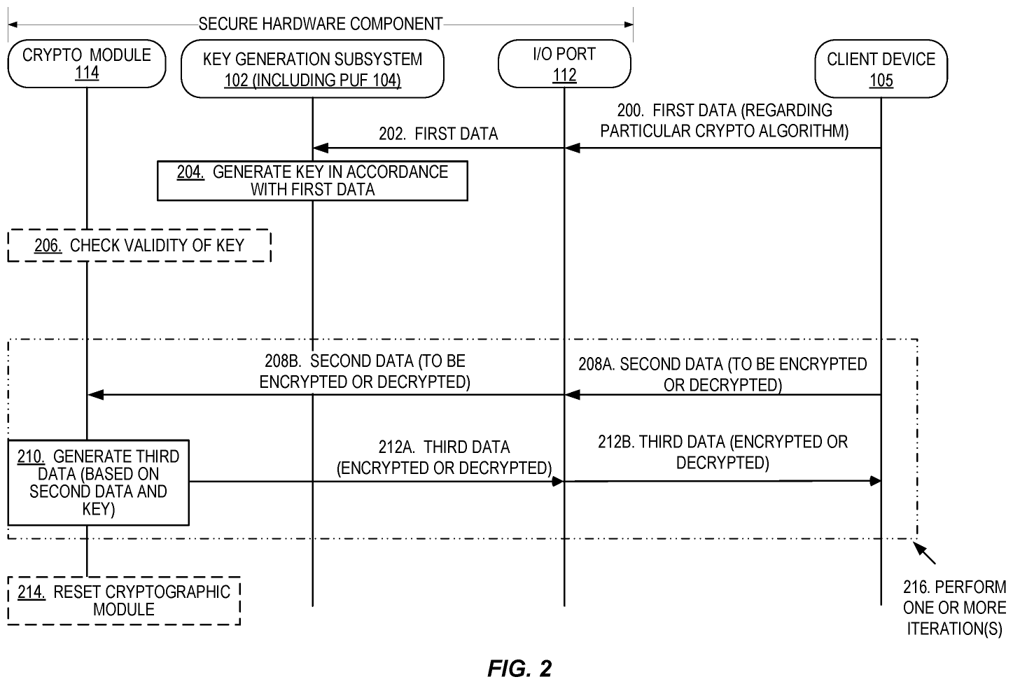

FIG. 2 is a flow diagram illustrating a method implemented in the secure hardware component 100 for the generation and operation modes described above, in accordance with some embodiments of the present disclosure. Optional steps are represented by dashed lines/boxes. As illustrated, the method includes the following steps:
Step 200: The I/O port 112 receives first data related to at least one cryptographic algorithm from the client device 105.
Step 202: The I/O port 112 provides the first data to the key generation subsystem 102. This may be done directly or indirectly through another sub-component, such as the controller 116.
Step 204: After receiving the first data related to the at least one cryptographic algorithm from the client device 105 via the I/O port 112, the key generation subsystem 102 generates a key for the at least one cryptographic algorithm in accordance with the first data using the PUF 104.
Step 206: Optionally, the key generation subsystem 102 checks the validity of the generated key.
Steps 208A and 208B: The cryptographic module 114 receives second data (e.g., to be encrypted or decrypted or have some other cryptographic operation performed thereon) from the client device 105 via the I/O port 112.
Step 210: The cryptographic module 114 generates third data based on the second data and the key using a cryptographic operation (e.g., encryption, decryption, etc.).
Steps 212A and 212B: The cryptographic module 114 provides the third data to the client device 105 via the I/O port 112.
   Step 216: One or more iterations of the steps from 208A and 208B may be performed.
Step 214 (Optional): The cryptographic module 114 is reset after finishing one or more iterations of the steps of (i) receiving the second data, (ii) generating the third data based on the second data and the key, and (iii) providing the third data to the client device 105 via the I/O port 112.

The first data sent from the client device 105 to the I/O port 112 may include, for example: (a) an identifier associated with at least one of service, a memory area, or an application, (b) an indicator of the at least one cryptographic algorithm, (c) a number of bits as a size of the key, (d) an Initialization Vector, (e) a counter related to a block of data to be encrypted, (f) additional data related to an encryption algorithm and mode of operation, or (g) a combination of any two or more of (a)-(f).

Optionally, in step 206 described above, the cryptographic module 114 checks the validity of the key before the cryptographic module 114 generates the third data based on the second data and the key. In one embodiment, the validity of the key is checked by decrypting a known ciphertext with the key by checking the key against a corresponding public key or by calculating a one-way transformed version of the key and comparing it against a stored one-way transformed version of the key.

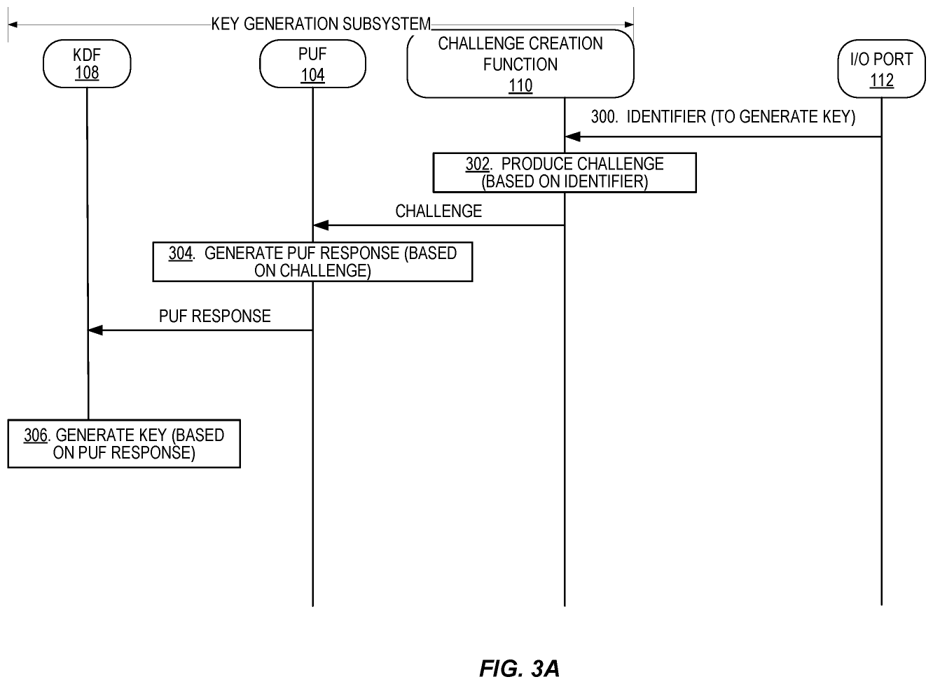

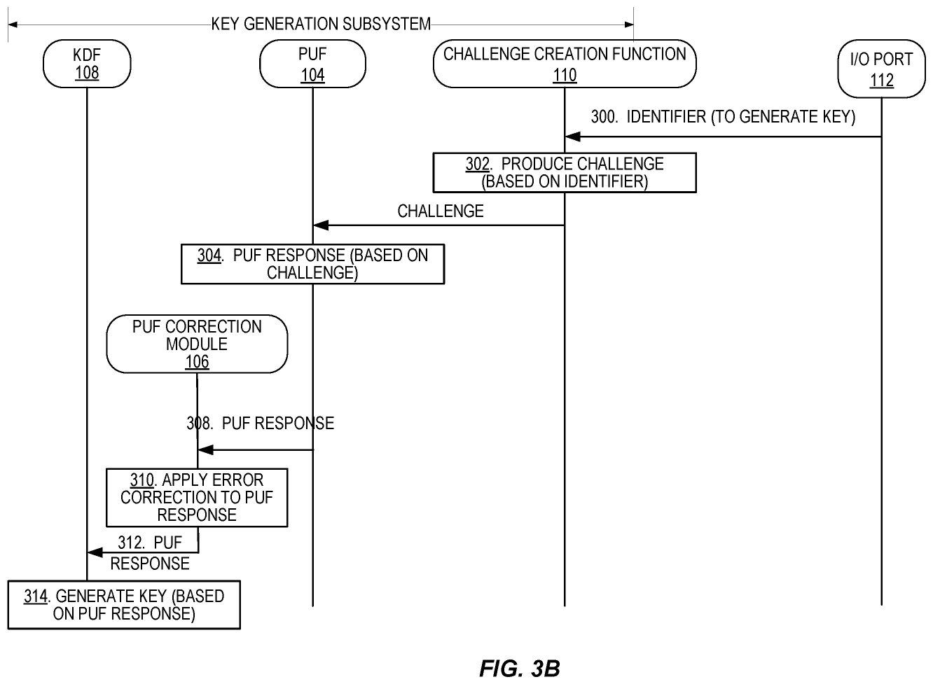

FIG. 3A is a flow diagram illustrating a method implemented in the key generation subsystem 102 for the generation mode in accordance with some embodiments of the present disclosure. In other words, the procedure of FIG. 3A is one exemplary implementation of step 204 of FIG. 2. As illustrated, in this example, the key generation subsystem 102 includes the challenge creation function 110, the PUF 104, and the KDF 108. The challenge creation function 110 receives first data including an identifier from the client device 105 via the I/O port 112 (step 300). The identifier is transformed by the challenge creation function 110 into a challenge to be provided to the PUF 104 to generate a key. For example, the identifier may be associated with a service, a memory area, or an application of the client device 105. The challenge creation function 110 produces a challenge based on the received identifier (step 302). The PUF 104 generates a PUF response based on the challenge (step 304). The KDF 108 generates the key, based on the PUF response (step 306). The key may additionally also be based on a key context. The KDF 108 uses a deterministic algorithm to generate the key based on the PUF response. Any suitable deterministic algorithm may be used. Further, the KDF 108 generates the key in accordance with one or more rules associated to the particular cryptographic algorithm for which the key is to be used. Different cryptographic algorithms have different requirements for the key, as will be appreciated by one of ordinary skill in the art. As such, the manner in which the key is generated from the PUF response will vary depending on the particular cryptographic algorithm(s) for which the key is generated.

FIG. 3B is a flow diagram illustrating another method implemented in the key generation subsystem 102 in accordance with an error correction feature of the present disclosure. In other words, the procedure of FIG. 3B is another example implementation of step 204 of FIG. 2. In this example, the key generation subsystem 102 includes the challenge creation function 110, the PUF 104, the KDF 108, and the PUF correction module 106. The challenge creation function 110 receives the first data from the client device 105 via the I/O port 112, where, in this example, the first data includes an identifier (step 300). The challenge creation function 110 produces a challenge based on the received identifier (step 302). The PUF 104 generates a PUF response based on the challenge (step 304) and the PUF response is provided to the PUF correction module 106 (step 308). Then, the PUF correction module 106 applies an error correction to the PUF response to provide an error-corrected PUF response (step 310). The error correction may comprise (a) error-correcting codes responsive to the specific PUF response such as Bose-Chaudhuri-Hocquenghem (BCH) codes or Reed-Muller codes, (b) general knowledge of the PUF 104, such as unstable bits, or (c) both (a) and (b). The error-corrected PUF response is transmitted from the PUF correction module 106 to the KDF 108 (step 312).

The KDF 108 generates the key based on the error-corrected PUF response (step 314). The KDF 108 uses a deterministic algorithm to generate the key based on the error-corrected PUF response. Any suitable deterministic algorithm may be used. Further, the KDF 108 generates the key in accordance with one or more rules associated with the particular cryptographic algorithm for which the key is to be used. Different cryptographic algorithms have different requirements for the key, as will be appreciated by one of ordinary skill in the art. As such, the manner in which the key is generated from the PUF response will vary depending on the particular cryptographic algorithm(s) for which the key is generated.

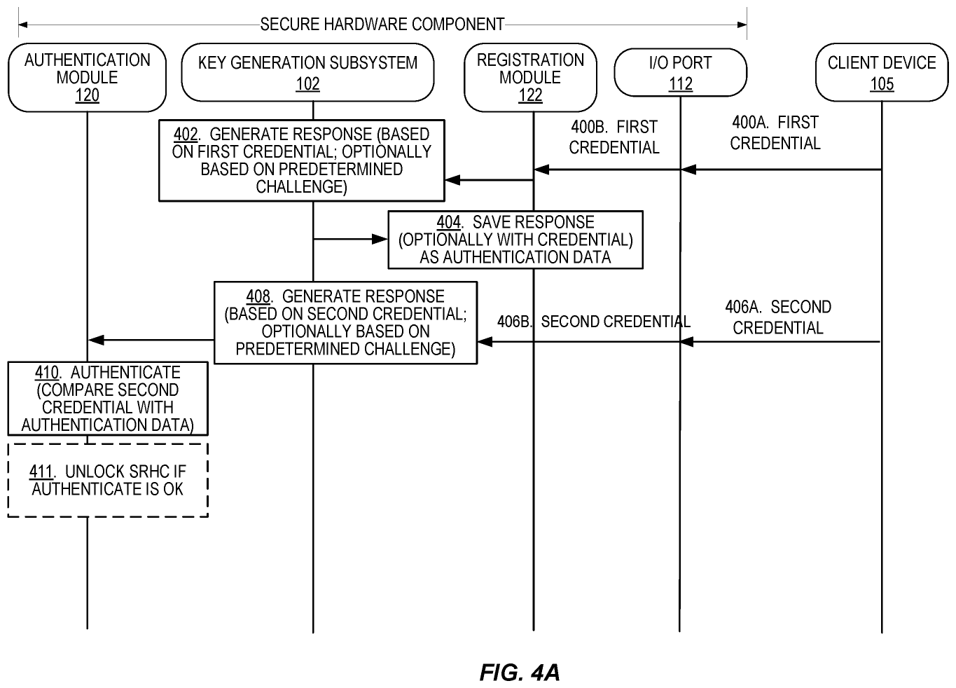

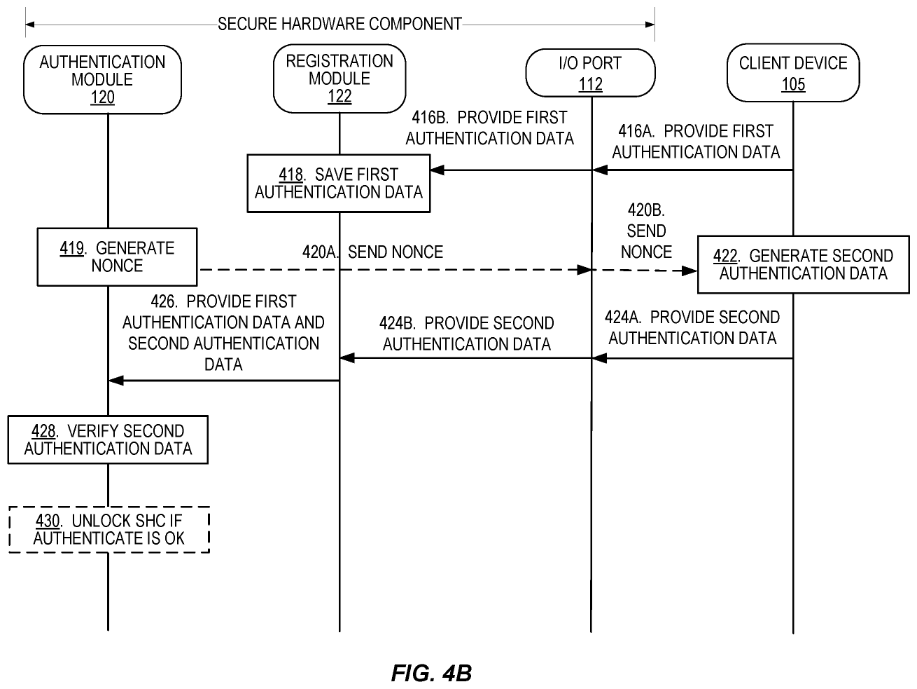

FIG. 4A is a flow diagram illustrating a method implemented in the secure hardware component 100 for the registration mode and the authentication mode, in accordance with an embodiment of the present disclosure. Again, optional steps are represented by dashed lines/boxes. The registration and authentication may be performed prior to the processes of FIGS. 2, 3A, and 3B.

In this example, the secure hardware component 100 includes the I/O port 112, the key generation subsystem 102, the authentication module 120, and the registration module 122. The registration module 122 receives a first credential from the client device 105 via the I/O port 112 during a registration phase (steps 400A and 400B). As discussed above, the first credential may be a password, a PIN, biometric data, or the like. The key generation subsystem 102 generates a PUF response based on the first credential (step 402). Next, the registration module 122 saves a first authentication data (e.g., in the memory 118) that is based on the response (optionally with the credential) of step 402 (step 404). In one embodiment, the first authentication data is generated based on the response of step 402. In another embodiment, the response of step 402 is stored as the first authentication data. Optionally, the response may be combined with the first credential, and then the combination of the response and the first credential may be saved as the first authentication data. In this case, the response of step 402 may be generated using a predetermined challenge, i.e., a challenge not based on the first credential.

Sometime thereafter, during authentication, the key generation subsystem 102 receives a second credential from the client device 105 via the I/O port 112 during an authentication phase (steps 406A and 406B). The key generation subsystem 102 generates a PUF response based on the second credential (step 408) and the authentication module 120 compares a second authentication data that is based on the response of step 408 with the first authentication data stored at the secure hardware component 100 to authenticate the second credential (step 410). Optionally, if the second credential is authenticated, the secure hardware component 100 is unlocked (step 411).

In one embodiment, the second authentication data is generated based on the response of step 408. In another embodiment, the response of step 408 is used as the second authentication data. Optionally, the response of step 408 may be combined with the second credential. That is, the combination of the response and the second credential may be used as the second authentication data. In this case, the response in step 408 may be generated using a predetermined challenge, i.e., a challenge not based on the second credential.

FIG. 4B is a flow diagram illustrating a method implemented in the secure hardware component 100 for the registration mode and the authentication mode, in accordance with an embodiment of the present disclosure. Again, optional steps are represented by dashed lines/boxes. The registration and authentication may be performed prior to the processes of FIGS. 2, 3A, and 3B.

In this example, the secure hardware component 100 includes the I/O port 112, the authentication module 120, and the registration module 122. The authentication module 120 may utilize an asymmetric key authentication scheme. The authentication module 120 is either preconfigured with a verification public key or configured to receive a first authentication data containing a verification public key or a digital certificate from the client device 105 via the I/O port 112 during a registration phase (steps 416A and 416B).

Sometime thereafter, during authentication, the authentication module receives the second authentication data based on the client device's private key (step 424). Optionally, the authentication module generates a nonce (step 419) and supplies the nonce to the client device 105 (step 420). In this case, the second authentication data is generated based on the nonce and the client device's private key (step 422). The authentication module 120 receives the first authentication data (for example, a verification public key or a digital certificate) and the second authentication data (for example, the client device's private key) from the registration module 122 (step 426). The authentication module 120 utilizes the public key and verifies the authenticity of the second authentication data (step 428). When the authenticity of the second authentication data is verified, the secure hardware component 100 is unlocked (step 430).

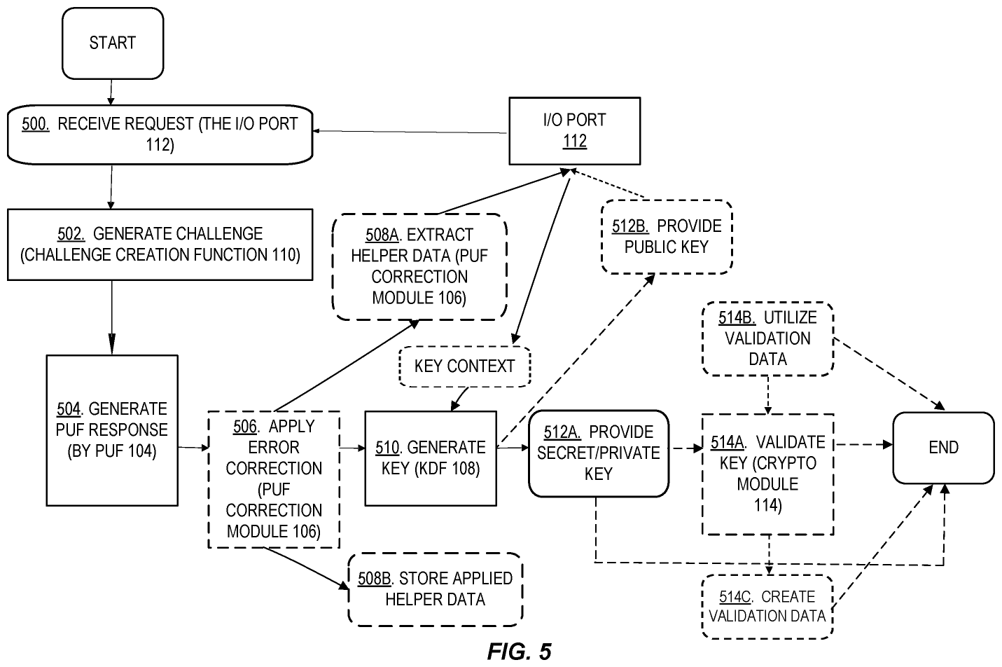

FIG. 5 is a flow chart illustrating a method implemented in the secure hardware component 100 for a first-time generation of a cryptographic key in accordance with an embodiment of the present disclosure. This process may be seen as illustrating one example of steps 200 to 204 of FIG. 2 or one example of the process of FIG. 3A or 3B. The I/O port 112 receives a key generation request (e.g., including the identifier, an indication of one or more particular algorithms, and a number of bits for the length of the cryptographic key) from the (external) client device 105 (step 500). The challenge creation function 110 receives at least a portion of the first data (e.g., the identifier in the example of FIG. 5) from the I/O port X112, generates a challenge based on the at least a portion of the first data, and forwards the challenge to the PUF 104 (step 502). The PUF 104 generates a PUF response based on the challenge (step 504). The PUF 104 may generate the response several times to facilitate the creation of error correction helper data. Optionally, the PUF correction module 106 applies an error correction to the PUF response to provide an error-corrected PUF response to the KDF 108 (step 506). Optionally, the KDF 108 may receive a key context prior to the generation of the cryptographic key. Optionally, the PUF correction module 106 extracts and outputs helper data associated with the PUF response, via the I/O port 112, to the client device 105 (step 508A). Optionally, the PUF correction module 106 saves the applied helper data locally, e.g., in the helper data database 118A of the memory 118 (step 508B).

The KDF 108 generates a secret/private key (and optionally a public key if the intended cryptographic algorithm is asymmetrical) based on the PUF response (step 510) optionally along with the key context included in the key generation request sent by the client device 105. Optionally, the KDF 108 provides a public key, via the I/O port 112, to the client device 105 (step 512B). The KDF 108 provides the generated (secret/private) key to the cryptographic module 114 (step 512A). Optionally, the cryptographic module 114 validates the generated key (step 514A) by utilizing validation data (step 514B) such as a known ciphertext. Optionally and alternatively, the cryptographic module 114 creates validation data for the cryptographic key, e.g., a stored one-way transformed version of the key or a known ciphertext (step 514C).

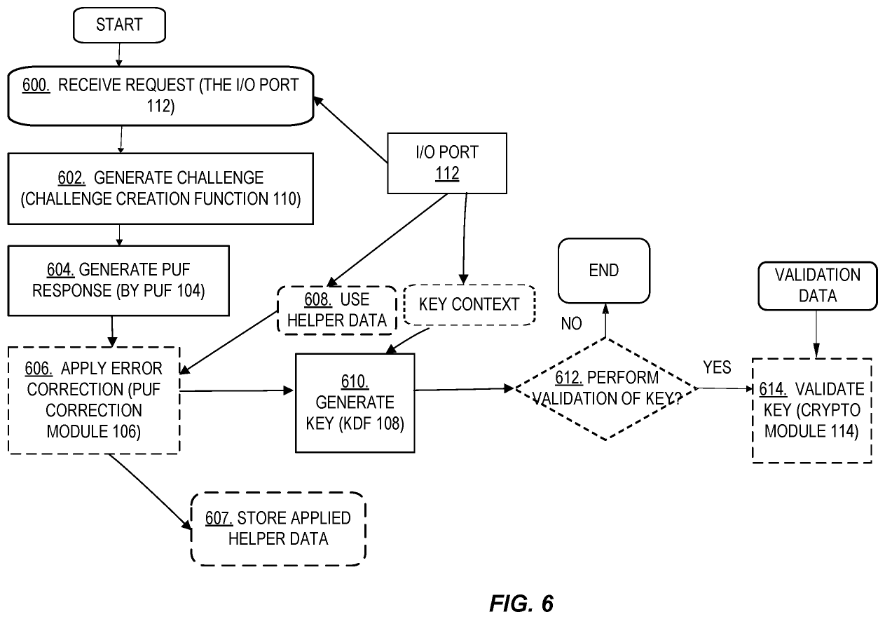

FIG. 6 is a flow chart illustrating a method of steps involved in the recreation of the previously produced cryptographic key. This process may be seen as illustrating one example of steps 200 to 204 of FIG. 2 or one example of the process of FIG. 3A or 3B. The I/O port 112 receives a key recreation request (e.g., including the identifier, one or more particular algorithms, and a number of bits for the length of the cryptographic key) from the (external) client device 105 (step 600). The challenge creation function 110 receives at least a portion of the first data (the identifier in this example) from the I/O port X112, generates a challenge based on the received identifier, and forwards the challenge to the PUF 104 (step 602). The PUF 104 generates a PUF response based on the challenge (step 604). Optionally, the PUF correction module 106 applies an error correction to the PUF response by utilizing the helper data (steps 606 and 608) and provides an error-corrected PUF response to the KDF 108. Optionally, the PUF correction module 106 saves the applied helper data locally, e.g., in the helper data database 118A of the memory 118 (step 607).

The KDF 108 receives the (error-corrected) PUF response along with the key context included in the key recreation request sent by the client device 105. The KDF 108 recreates a cryptographic key based on the (error-corrected) PUF response, the particular cryptographic algorithm information, and the bit information (step 610). Optionally, the key may be validated by the cryptographic module 114 (step 612). If the key is to be validated, the cryptographic module 114 performs the validation process by taking validation data as input (step 614). If the key is not to be validated, the process ends.

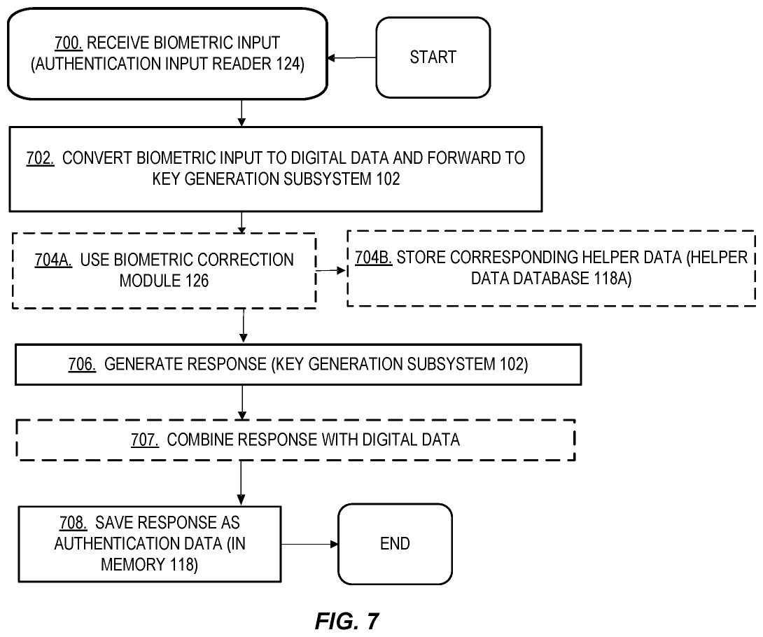

FIG. 7 is a flow chart illustrating a method of another registration mode with a biometric input in accordance with some embodiments of the present disclosure. In lieu of using a password/PIN, the biometric input can be used to authenticate the user. The authentication input reader 124 (included in the registration module 122) receives a biometric input from the client, such as a user (step 700). The authentication input reader 124 converts the biometric input (in an analog form such as a fingerprint, a face scan, a retina, etc.) into digital data which represents the biometric input (step 702).

Optionally, the digital data is forwarded from the registration module 122 to the biometric correction module 126. Depending on the types of biometric input, the digital data may need to be preprocessed, such as scaling, alignment, and rotation, by using the biometric correction module 126 (step 704A). It is important that the same biometric input is recreated to ensure the authentication data is a match. This can be solved by storing helper data (corresponding to the biometric input) during the registration phase in order to facilitate the recreation of the same feature set in authentication mode (step 704B). For example, fuzzy extraction, which is a function creating the same deterministic response (such as a binary string) from inputs that have low hamming distance, can be used to generate a challenge from the biometric input. The key generation subsystem 102 generates a PUF response based on the digital data of the biometric input (step 706). The registration module 122 saves the response as a first authentication data in the memory 118 (step 708). Optionally, the response of step 706 may be combined with the digital data (step 707), and then the combination of the response of step 706 and the digital data may be used as the first authentication data. In this case, the response of step 706 may be generated using a predetermined challenge, i.e., a challenge not based on the digital data.

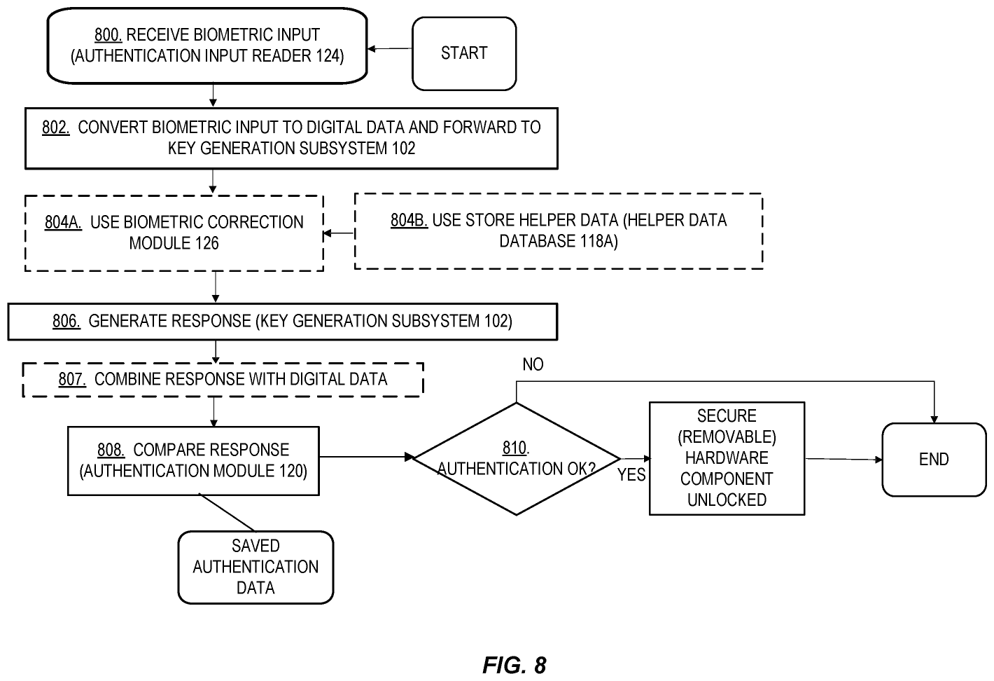

FIG. 8 is a flow chart illustrating a method of another authentication mode with the biometric input in accordance with some embodiments of the present disclosure. The authentication input reader 124 (included in the registration module 122) receives a biometric input from the client, such as a user (step 800). The authentication input reader 124 converts the biometric input (in analog form) into digital data which represents the biometric input (step 802).

Optionally, the registration module 122 forwards the converted digital data to the biometric correction module 126, which performs certain preprocessing actions, such as scaling, alignment, and rotation, based on the stored helper data (step 804A). The biometric correction module 126 optionally stores helper data (corresponding to the biometric input) (step 804B). The key generation subsystem 102 generates a PUF response based on the digital data (step 806). The authentication module 120 then compares the second authentication data (the PUF response) with the stored first authentication data for authentication (step 808). If the authentication is successful (step 810; YES), the secure hardware component 100 is unlocked, and if not successful, the authentication process is stopped (step 810). Optionally, the response of step 806 may be combined with the digital data (step 807), and then the combination of the response of step 806 and the digital data may be used as the second authentication data. In this case, the response of step 806 may be generated using a predetermined challenge, i.e., a challenge not based on the digital data.

### Use Cases

A use case of encryption of data is discussed herein. The client has a device, e.g., a laptop, which contains sensitive plaintext data. The goal is to create a new cryptographic key on the Secure Removable Hardware Component (SRHC) to use for the encryption of this data. The SRHC is interchangeably used with the secure hardware component (SHC) and the SRHM. It is assumed that the client has previously registered to the device using a password. The followings are steps about encrypting the data:
1. The client attaches the SRHC to the device.
2. The client sends a password to the SRHC which is used to produce a challenge for the PUF. The PUF response has a low distance compared to the stored authentication data. The SRHC is successfully unlocked.
3. The client sends an identifier, algorithm, and number of bits to the device.
4. The SRHC generates a key using a one-way transformed version of the identifier as an input to the PUF.
5. The SRHC generates helper data (used to recreate the key) and outputs it to the client.
6. The SRHC sets up the cryptographic module using the generated cryptographic key.
7. The SRHC encrypts test data stored in the memory (such as Non-Volatile Memory (NVM)) to enable validation of the key when it is recreated at a later time.
8. The client supplies sensitive plaintext data to be encrypted.
9. The SRHC encrypts the data with the cryptographic key, using the cryptographic module, and outputs the encrypted data.
10. When all data has been encrypted, the SRHC resets the cryptographic module.
11. The client removes the SRHC from the client device. The SRHC locks, requiring new authentication for the next operation.

A use case of decryption of data is discussed herein. Assuming that the client has encrypted data on the device, which was created in the above encryption procedure, the followings are steps about decrypting the data:
1. The client attaches the SRHC to the client device.
2. The client sends a password to the SRHC, which is used to produce a challenge for the PUF. The PUF response has a low distance compared to the stored authentication data. The SRHC is successfully unlocked.
3. The client sends an identifier, helper data, one or more particular algorithm(s), and a number of bits to the client device.
4. The SRHC generates a key using a one-way transformed version of the identifier as an input to the PUF.
5. The SRHC supplies helper data to the error correction module and corrects the PUF response which is used to create the key.
6. The SRHC sets up the cryptographic module using the generated cryptographic key.
7. The SRHC validates that the key is correctly recreated by decrypting the test data.
8. The client supplies the data to be decrypted.
9. The SRHC decrypts the data using the cryptographic module and outputs the decrypted data.
10. When all data has been decrypted, the SRHC resets the cryptographic module.
11. The client removes the SRHC from the device. The SRHC locks, requiring new authentication for the next operation.

A use case of decryption of boot stage is discussed herein. The client has a device, e.g., a mobile phone, which has a (partially) encrypted boot component. For example, the encrypted part may contain cryptographic keys needed for subsequent boot steps, executable code, and/or metadata. The goal is to decrypt the boot component in order to start the device. A process similar to the above use of encryption of data is assumed to have been performed prior to the process described below.
1. The client attaches the SRHC to the device, either through a physical port (e.g., USB Type-C) or wireless (e.g., NFC).
2. The client sends a credential, such as a password/PIN, to the SRHC which is used to produce a challenge for the PUF. The PUF response has a low distance compared to the stored authentication data. The SRHC is successfully unlocked.
3. The device sends an identifier (and possibly an algorithm and a number of bits) to the SRHC.
4. The SRHC generates a key using a one-way transformed version of the identifier as input to the PUF.
5. The SRHC supplies previously generated helper data to the error correction module and corrects the PUF response which is used to create the key.
6. The SRHC sets up the cryptographic module using the generated cryptographic key.
7. The SRHC validates that the key is correctly recreated by decrypting the test data.
8. The client supplies the boot component (or a part of the boot component) to be decrypted.
9. The SRHC decrypts the data using the cryptographic module and outputs the decrypted data.
10. When all data has been decrypted, the SRHC resets the cryptographic module.
11. The device now has the cleartext boot component and may continue booting.
12. The client removes the SRHC from the device. The SRHC locks, requiring new authentication for next operation.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is any inconsistency between abbreviations, preference should be given to how it is used above. If listed multiple times below, the first listing should be preferred over any subsequent listing(s).
ASIC Application Specific Integrated Circuit
BBRAM Battery Backup Random Access Memory
CPU Central Processing Unit
CRPs Challenge Response Pairs
FIB Focused Ion Beams
FPGA Field-Programmable Gate Array
HSM Hardware Security Module
ID Identifier
I/O Input/Output
IV Initialization Vector
KDF Key Derivation Function
KEK Key Encryption Key
LFSR Linear Feedback Shift Register
LUT Lookup Table
MAC Medium Access Control
MTP Multiple Time Programmable
NFC Near Field Communication
NVM Non-Volatile Memory
OTP One Time Programmable
OWF One-Way Function
PBKDF2 Password-Based Key Derivation Function 2
PIN Personal Identification Number
PKCS Public Key Cryptography Standards
PRNG Pseudo Random Number Generator
PUF Physically Unclonable Function
RFID Radio Frequency Identification
RNG Random Number Generator
RSA Rivest, Shamir, Adleman
SD Secure Digital
SE Secure Element
SEM Scanning Electron Microscope
SIM Subscriber Identity Module
SHC Secure Hardware Component
SRAM Static Random Access Memory
SRHC Secure Removable Hardware Component
SRHM Secure Removable Hardware Module
UICC Universal Integrated Circuit Card
USB Universal Serial Bus

Those skilled in the art will recognize improvements and modifications to the embodiments of the present disclosure. All such improvements and modifications are considered within the scope of the concepts disclosed herein.

1. A secure hardware component comprising:
an Input/Output, I/O, port configured to exchange data with a client device;
a key generation subsystem coupled to the I/O port; and
a cryptographic module,
wherein:
the key generation subsystem comprises a Physically Unclonable Function, PUF, wherein the key generation subsystem is configured to:
receive first data related to at least one cryptographic algorithm from the client device via the I/O port; and
generate a key for the at least one cryptographic algorithm in accordance with the first data using the PUF; and
the cryptographic module is configured to:
receive second data from the client device via the I/O port;
generate third data based on the second data and the key; and
provide the third data to the client device via the I/O port.

2. The secure hardware component of claim 1 is removable from the client device.

3. The secure hardware component of claim 1, wherein the cryptographic module is reset after finishing one or more iterations of receiving the second data, generating the third data based on the second data and the key, and providing the third data to the client device via the I/O port.

4. The secure hardware component of claim 1, wherein the first data comprises: (a) an identifier associated with at least one of service, a memory area, or an application, (b) an indicator of the at least one cryptographic algorithm, (c) a number of bits as a size of the key, (d) an Initialization Vector, IV, (e) a counter related to a block of data to be encrypted, (f) additional data related to an encryption algorithm and mode of operation, (g) additional data related to generation of a cryptographic key, or (h) a combination of any two or more of (a)-(g).

5. The secure hardware component of claim 1, wherein the key generation subsystem further comprises a challenge creation function and a Key Derivation Function, KDF, wherein:
the challenge creation function is configured to produce a challenge based on the first data;
the PUF is configured to generate a PUF response based on the challenge; and
the KDF is configured to generate the key based on the PUF response.

6. The secure hardware component of claim 1, wherein
the key generation subsystem further comprises a challenge creation function, a PUF correction module, and a Key Derivation Function, KDF, wherein:
the challenge creation function is configured to produce a challenge based on the first data;
the PUF is configured to generate a PUF response based on the challenge;
the PUF correction module is configured to apply an error correction to the PUF response to provide an error-corrected PUF response; and
the KDF is configured to generate the key based on the error-corrected PUF response.

7. The secure hardware component of claim 5 wherein the challenge creation function comprises a One-Way Function, OWF.

8. The secure hardware component of claim 5 wherein the challenge creation function comprises a deterministic Pseudo Random Number Generator, PRNG.

9. The secure hardware component of claim 5 wherein the challenge creation function comprises a Lookup Table, LUT.

10. The secure hardware component of claim 1, wherein the cryptographic module is configured to generate the third data by encrypting the second data with the key.

11-24. (canceled)

25. A method implemented in a secure hardware component comprising an Input/Output, I/O, port configured to exchange data with a client device, a key generation subsystem that is coupled to the I/O port and comprises a Physically Unclonable Function, PUF, and a cryptographic module, the method comprising:
at the key generation subsystem comprising the PUF:
receiving first data related to at least one cryptographic algorithm from the client device via the I/O port; and
generating a key for the at least one cryptographic algorithm in accordance with the first data using the PUF; and
at the cryptographic module,
receiving second data from the client device via the I/O port;
generating third data based on the second data and the key; and
providing the third data to the client device via the I/O port.

26. The method of claim 25 wherein the secure hardware component is removable from the client device.

27. The method of claim 25 further comprising resetting the cryptographic module after finishing one or more iterations of (i) receiving the second data, (ii) generating the third data based on the second data and the key, and (iii) providing the third data to the client device via the I/O port.

28. The method of claim 25 wherein the first data comprises: (a) an identifier associated with at least one of service, a memory area, or an application, (b) an indicator of the at least one cryptographic algorithm, (c) a number of bits as a size of the key, (d) an Initialization Vector, IV, (e) a counter related to a block of data to be encrypted, (f) additional data related to an encryption algorithm and mode of operation, (g) additional data related to generation of a cryptographic key, or (h) a combination of any two or more of (a)-(g).

29. The method of claim 25 further comprising the key generation subsystem comprising a challenge creation function and a Key Derivation Function, KDF:
a. producing a challenge based on the first data;
b. generating, by the PUF, a PUF response based on the challenge; and
c. generating the key based on the PUF response.

30. The method of claim 25 further comprising:
at the key generation subsystem comprising a challenge creation function, a PUF correction module, and a Key Derivation Function, KDF:
producing a challenge based on the first data;
generating, by the PUF, a PUF response based on the challenge; and
applying an error correction to the PUF response to provide an error-corrected PUF response; and
generating the key based on the error-corrected PUF response.

31. The method of claim 29 wherein producing the challenge comprises applying a One-Way Function, OWF, to at least a component of the first data.

32. The method of claim 29 wherein the challenge creation function comprises a deterministic Pseudo Random Number Generator, PRNG.

33. The method of claim 29 wherein producing the challenge comprises obtaining the challenge from a Lookup Table, LUT, based on at least a component of the first data.

34. The method of claim 25 wherein generating the third data comprises encrypting the second data with the key.

35. The method of claim 25 wherein generating the third data comprises decrypting the second data with the key.

36-48. (canceled)
